(19) United States
(12) Patent Application Publication
(10) Pub. No.: US 2025/0342995 A1
(43) Pub. Date: Nov. 6, 2025

(54) INDUCTOR ASSEMBLY AND VOLTAGE REGULATOR MODULE WITH LOW THERMAL RESISTANCE

(71) Applicant: SHANGHAI METAPWR ELECTRONICS CO., LTD, Shanghai (CN)

(72) Inventors: Mingzhun ZHANG, Shanghai (CN); Xiaoni Xin, Shanghai (CN)

(73) Assignee: SHANGHAI METAPWR ELECTRONICS CO., LTD, Shanghai (CN)

(21) Appl. No.: 19/199,405

(22) Filed: May 6, 2025

(30) Foreign Application Priority Data
May 6, 2024 (CN) 202410550658.3
Jul. 18, 2024 (CN) 202410968452.2
Aug. 5, 2024 (CN) 202411066455.3

(51) Int. Cl. H01F 27/08; H01F 27/255; H01F 27/30

(52) U.S. Cl. CPC H01F 27/08; H01F 27/255; H01F 27/306

(57) ABSTRACT

A voltage regulation module with low thermal resistance is provided. The voltage regulation module includes a top inductor and a bottom assembly. The top inductor includes a magnetic core and a winding, and the winding includes a first winding and a second winding; the bottom assembly comprises a bottom substrate and an IPM unit. The first winding and the second winding both comprise a first pin and a second pin. The first pin and the second pin are both arranged on the bottom surface of the magnetic core and are electrically connected with the bottom substrate; and the inductor. The IPM unit and the bottom substrate are sequentially stacked. The upward thermal resistance of the voltage regulation module is reduced by optimally designing the shape structure of the inductor winding and optimizing the thermal connection between the inductor winding and the IPM unit.

### CROSS-REFERENCE TO RELATED APPLICATION

This application claims the priority benefit of China application serial no. CN 202410550658.3 filed on May 6, 2024, China application serial no. CN 202410968452.2 filed on Jul. 18, 2024, and China application serial no. CN 202411066455.3 filed on Aug. 5, 2024. The entirety of the above-mentioned patent application is hereby incorporated by reference herein and made a part of this specification.

### BACKGROUND

### Description of Related Art

In recent years, with the development of technologies such as data centers, artificial intelligence, supercomputers and the like, more and more ASICs with powerful functions are obtained, such as a CPU, a GPU, a machine learning accelerator, a network switch, a server and the like. These processors consume a large amount of current, for example, up to thousands of amperes, and their power demand rapidly fluctuates. On the other hand, along with the progress of the technology, the power supply voltage of the processor is lower and lower, for example, lower than 1V, the bottleneck of the voltage regulation module (VRM) of the low-voltage large current is the heat dissipation of the voltage regulation module, and the heat dissipation limits the improvement of the output current of the voltage regulation module.

The invention mainly provides a voltage regulation module with low thermal resistance. The module is good in heat dissipation performance, large in output current and high in efficiency so as to solve the bottleneck of power supply of a current processor.

### SUMMARY

In view of the above, one of the objectives of the invention is to provide a inductor assembly with low thermal resistance, the inductor assembly comprises a magnetic core and a winding; the winding comprises a first winding and a second winding; the magnetic core comprises a top surface and a bottom surface which are opposite each other, a first surface and a third surface which are opposite each other, a second surface and a fourth surface which are opposite each other; the first surface, the second surface, the third surface and the fourth surface are arranged between the top surface and the bottom surface;

the first winding and second winding both comprise a top-horizontal part, a first vertical part, a second vertical part, a first bottom-horizontal part, a first pin and a second pin; the first pin and the second pin are arranged on the bottom surface of the magnetic core; the upper surface of the top-horizontal part is exposed on the top surface of the magnetic core; the top ends of the first and second vertical parts connect to respective ends of the top-horizontal part; the bottom end of the first vertical part connects to one end of the first bottom-horizontal part; the lower surface of the first bottom-horizontal part is exposed on the bottom surface of the magnetic core; the first vertical part is disposed adjacent to the first pin, the second vertical part is disposed adjacent to the second pin.

Preferably, a side surface of the second vertical part is exposed on a side surface of the magnetic core.

Preferably, the first bottom-horizontal part extends from the first vertical part toward the side surface of the magnetic core away from the second vertical part.

Preferably, the inductor assembly further comprises a third vertical part; the top end of the third vertical part connects to the other end of the first bottom-horizontal part; the first pin is disposed on the bottom end of the third vertical part.

Preferably, the first pin is disposed on the bottom surface of the first bottom-horizontal part.

Preferably, the first bottom-horizontal part extends to the second vertical part.

Preferably, the second pin is disposed on the bottom end of the second vertical part.

Preferably, the inductor assembly further comprises a second bottom-horizontal part; one end of the second bottom-horizontal part connects with the bottom end of the second vertical part; the second bottom-horizontal part extends from the second vertical part away from the first vertical part; the second pin is disposed on the bottom surface of the second bottom-horizontal part.

Preferably, the inductor assembly further comprises a second bottom-horizontal part and a fourth vertical part; one end of the second bottom-horizontal part connects with the bottom end of the second vertical part; the other end of the second bottom-horizontal part connects with the top end of the fourth vertical part; the second pin is disposed on the bottom end of the fourth vertical part.

Preferably, the second vertical part of the first winding and the second vertical part of the second winding connect each other; or the top-horizontal part and the second vertical part of the first winding connect with the top-horizontal part and the second vertical part of the second winding.

Preferably, the inductor assembly further comprises a heat dissipation assembly; the heat dissipation assembly is in “C” shape, wrapping part of the top surface, part of the side surface and part of the bottom surface of the magnetic core; the heat dissipation assembly is made of metal material.

Preferably, the first winding comprises a first notch, the first notch is arranged on the bottom surface of the top-horizontal part of the first winding; the second winding comprises a second notch, the second notch is arranged on the top surface of the second winding; the first winding and the second winding are arranged in a crossed configuration through the mechanical interlock between the first notch and the second notch.

Preferably, the first winding comprises a first notch, the first notch is arranged at the combination part of the first bottom-horizontal part and the first vertical part of the first winding; the second winding comprises a second notch, the second notch is arranged at the combination part of the second bottom-horizontal part and the second vertical part of the second winding; the first winding and the second winding are arranged in a crossed configuration through the mechanical interlock between the first notch and the second bottom-horizontal part of the second winding, and through the mechanical interlock between the second notch and the first bottom-horizontal part of the first winding.

Preferably, the first pin of the first winding and the first pin of the second winding are arranged adjacent the same side surface of the magnetic core; the second pin of the first winding and the second pin of the second winding are arranged adjacent the other same side surface of the magnetic core.

Preferably, the bottom ends of the first winding and the second winding are flush with the bottom surface of the magnetic core; or the bottom ends of the first winding and the second winding both protrude out of the bottom surface of the magnetic core; or the bottom end of the first pin is flush with the bottom surface of the magnetic core, the bottom end of the second pin protrudes out of the bottom surface of the magnetic core.

Preferably, the inductor assembly further comprises a first auxiliary winding and a second auxiliary winding; the first auxiliary winding is arranged adjacent to the first winding; and the second auxiliary winding is arranged adjacent to the second winding; the two auxiliary winding both comprises a top-horizontal part, a first vertical part and a second vertical part; the shape of the top-horizontal part, the first vertical part and the second vertical part of the auxiliary winding is same as the shape of the top-horizontal part, the first vertical part and the second vertical part of the first winding and the second winding.

Preferably, magnetic powder, the first winding, and the second winding are integrally pressed to form the inductor assembly.

Preferably, the magnetic core comprises a first magnetic core, a second magnetic core and a third magnetic core; the third magnetic core is arranged between the first winding and the second winding; the first magnetic core and the third magnetic core are arranged two opposite side surfaces of the first winding; the second magnetic core and the third magnetic core are arranged at two opposite side surfaces of the second winding.

Preferably, the first magnetic core is provided with a middle column and a side column; the first magnetic core and the second magnetic core are made of a magnetic material with low magnetic permeability; the third magnetic core is made of a magnetic material with low magnetic permeability.

A voltage regulator module with low thermal resistance, comprises a bottom assembly and an inductor assembly; the bottom assembly includes a bottom substrate, a first IPM unit and a second IPM unit; the IPM units are arranged on the upper surface of the bottom substrate or embedded in the bottom substrate; each IPM unit comprises a high-end switch, a low-end switch and an SW pin, and the high-end switch and the low-end switch are electrically connected to the SW pin;

The inductor assembly is arranged on the top surface of the bottom substrate and arranged above the IPM unit; the bottom surface of the bottom substrate is used for fixing and electrically connecting with an external assembly; the second pins are electrically connected with the bottom substrate, the first pin of the first winding is electrically connected with the first IPM unit, the first pin of the second winding is electrically connected with the second IPM unit.

Preferably, the top-horizontal part is thermally connected with the heat dissipation device arranged on the top surface of the magnetic core.

Preferably, the voltage regulator module further comprises an input capacitor and other passive components; the input capacitor and other passive components are arranged on the top surface of the bottom substrate; the input capacitor is arranged between the first IPM unit and the second IPM unit.

Preferably, the bottom of the magnetic core is provided with a groove; the groove is used for accommodating the input capacitor and other passive components.

Preferably, an I/O pad, a Vin+ pad, a GND pad and a Vo+ pad are sequentially arranged on the bottom surface of the bottom substrate; and the I/O pad is arranged adjacent to the first side surface of the bottom substrate.

Preferably, the bottom surface of the magnetic core is thermally connected with the top surface of the bottom substrate or the IPM unit.

Preferably, the inductor assembly further comprises a heat dissipation assembly; the heat dissipation assembly is in “C” shape, wrapping part of the top surface, part of the side surface and part of the bottom surface of the magnetic core; the heat dissipation assembly is made of metal material; the bottom surface of the heat dissipation assembly is thermally connected with the top surface of the IPM unit or the bottom substrate.

Preferably, the bottom surface of the first bottom-horizontal part is thermally connected with the top surface of the IPM unit.

Preferably, the SW pin of the IPM unit is arranged on the top surface of the IPM unit; the bottom surface of the first bottom-horizontal part is fixed and electrically connected with the SW pin.

Preferably, thermal interface material is provided between the top surface of the IPM unit and the bottom surface of the magnetic core, and between the top surface of the IPM unit and the bottom surface of the first bottom-horizontal part.

Preferably, the inductor assembly further comprises a third vertical part; the top end of the third vertical part connects to the other end of the first bottom-horizontal part; the first pin is disposed on the bottom end of the third vertical part; the SW pin of the IPM unit is electrically connected with the first pin through the substrate.

Preferably, the second pin is disposed on the bottom end of the second vertical part; the second pin is fixed and electrically connected with the bottom substrate.

Preferably, the inductor assembly further comprises a second bottom-horizontal part; one end of the second bottom-horizontal part connects with the bottom end of the second vertical part; the second bottom-horizontal part extends from the second vertical part away from the first vertical part; the second pin is disposed on the bottom surface of the second bottom-horizontal part; the second pin is fixed, thermally connected and electrically connected with the bottom substrate.

Preferably, the inductor assembly further comprises a second bottom-horizontal part and a fourth vertical part; one end of the second bottom-horizontal part connects with the bottom end of the second vertical part; the other end of the second bottom-horizontal part connects with the top end of the fourth vertical part; the second pin is disposed on the bottom end of the fourth vertical part; the bottom surface of the second bottom-horizontal part is thermally connected with the top surface of the IPM unit; the second pin is fixed and electrically connected with the bottom substrate.

Preferably, thermal interface material is provided between the top surface of the IPM unit and the bottom surface of the second bottom-horizontal part.

Preferably, the bottom end of the second pin and/or the first pin is fixed and electrically connected with the bottom substrate through a metal column.

Preferably, the SW pin of the IPM unit is arranged adjacent to the first side surface of the bottom substrate, the first pin of the winding is arranged adjacent to the first side surface of the bottom substrate, and the SW pin and the first pin are arranged nearby.

Preferably, the inductor assembly further comprises a first auxiliary winding and a second auxiliary winding; the first auxiliary winding is arranged adjacent to the first winding; and the second auxiliary winding is arranged adjacent to the second winding; the two auxiliary winding both comprises a top-horizontal part, a first vertical part and a second vertical part; shapes of the top-horizontal part, the first vertical part, and the second vertical part of the first auxiliary winding and the second auxiliary winding are same as shapes of the top-horizontal part, the first vertical part, and the second vertical part of the first winding and the second winding; the first auxiliary winding and the second auxiliary winding in a same voltage regulator module are electrically connected in series through the bottom substrate, and a corresponding functional extension pin is arranged on the bottom surface of the bottom substrate.

Preferably, two notches are respectively provided on the first winding and the second winding; the first winding and the second winding are arranged in a crossed configuration through the mechanical interlock between the two notches.

A voltage regulator module with low thermal resistance, comprises a IPM unit, an input capacitor, other passive components and an inductor assembly; the IPM unit, the input capacitor, the other passive components and the inductor assembly are arranged on the bottom substrate or the system mainboard; the IPM unit and the inductor assembly are arranged on the same surface of the bottom substrate or the system mainboard;

The IPM unit is arranged on the upper surface of the bottom substrate; the IPM unit comprises a high-end switch, a low-end switch and SW pin, the high-end switch and the low-end switch are electrically connected with the SW pin;

The inductor is arranged on the top surface of the bottom substrate in coplanar alignment with the IPM unit; the second pins are electrically connected with the bottom substrate; and the first pin of the first winding and the SW pin of the first IPM unit are adjacently arranged and electrically connected.

Preferably, a pad of voltage regulator module is provided on the bottom surface of the bottom substrate, which is used for fixing and electrically connecting with an external assembly.

Preferably, the bottom substrate is a system mainboard; the IPM unit and the inductor assembly are electrically connected through the inductor assembly.

Compared with the prior art, the application has the following beneficial effects:

By stacking the inductor and the IPM unit, heat generated by the IPM unit is transmitted to the top surface of the inductor through the magnetic material of the inductor and the winding; and on the other hand, the upward thermal resistance of the voltage adjusting module is reduced by optimally designing the shape structure of the inductor winding and optimizing the thermal connection between the inductor winding and the IPM unit. Therefore, the voltage regulation module with low thermal resistance, good heat dissipation performance, large output current, high conversion efficiency and high power density is obtained.

### BRIEF DESCRIPTION OF THE DRAWINGS

FIG. 1A to FIG. 1D are structures of a voltage regulation module shown in Embodiment 1.

FIG. 2A to FIG. 2C are structures of a voltage regulation module shown in Embodiment 2.

FIG. 3A to FIG. 3C are structures of a voltage regulation module shown in Embodiment 3.

FIG. 4A to FIG. 4B are structures of a voltage regulation module shown in Embodiment 4.

FIG. 5A to FIG. 5B are structures of a voltage regulation module shown in Embodiment 5.

FIG. 6A to FIG. 6B are structures of a voltage regulation module shown in Embodiment 6.

FIG. 7A to FIG. 7D are structures of a voltage regulation module shown in Embodiment 7.

FIG. 8A to FIG. 8C are structures of a voltage regulation module shown in Embodiment 8.

FIG. 9A to FIG. 9F are structures of a voltage regulation module shown in Embodiment 9.

FIG. 10A to FIG. 10B are structures of a voltage regulation module shown in embodiment 10.

FIG. 11A to FIG. 11D are the structure of the voltage regulation module shown in embodiment 11.

FIG. 12A to FIG. 12F are structures of the voltage regulation module shown in embodiment 12.

### DESCRIPTION OF THE EMBODIMENTS

According to the low-thermal-resistance voltage regulation module, on one hand, the inductor and the intelligent power module (IPM) unit are stacked, and heat generated by the IPM unit is transmitted to the top surface of the inductor through the magnetic material of the inductor and the winding; and on the other hand, the upward thermal resistance of the voltage adjusting module is reduced by optimally designing the shape structure of the inductor winding and optimizing the thermal connection between the inductor winding and the IPM unit. Therefore, the voltage regulation module with low thermal resistance, good heat dissipation performance, large output current, high conversion efficiency and high power density is obtained.

The technical solutions in the embodiments of the present disclosure will be clearly and completely described below with reference to the accompanying drawings in the embodiments of the present disclosure. All other embodiments obtained by a person of ordinary skill in the art based on the embodiments of the present invention without creative efforts shall fall within the protection scope of the present invention.

### Embodiment 1

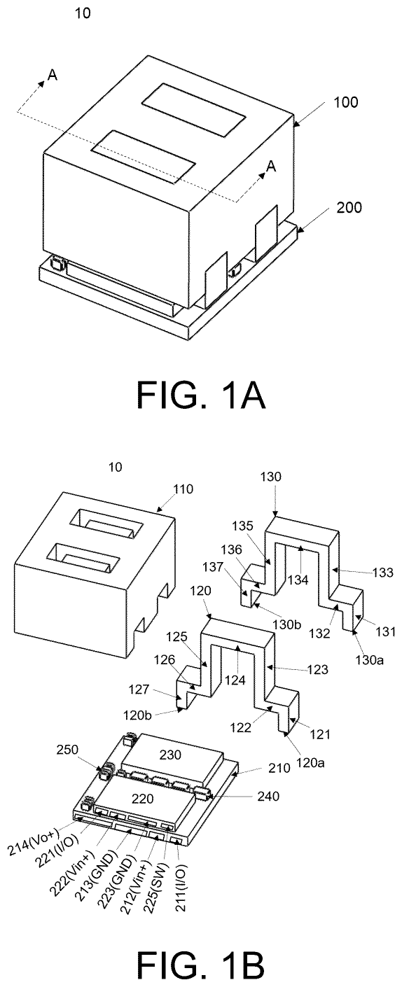

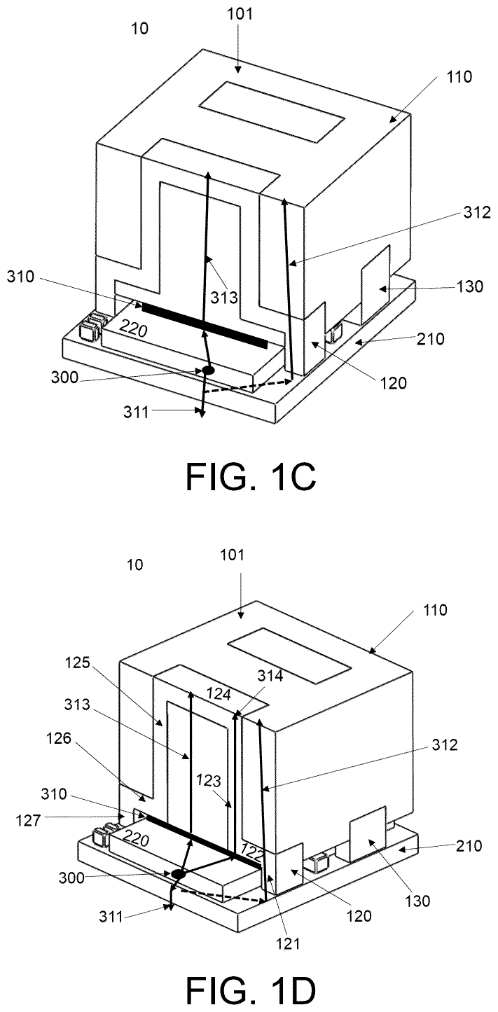

FIG. 1A is a schematic structural diagram of a VRM module 10 according to the present invention, and FIG. 1B is an exploded view of the structure of FIG. 1A. As shown in FIG. 1A and FIG. 1B, the VRM module 10 comprises a top inductor 100 and a bottom assembly 200, the top inductor 100 comprises a magnetic core 110 and a first winding 120 and a second winding 130. The bottom assembly 200 comprises a bottom substrate 210, a first IPM unit 220, a second IPM unit 230, an input capacitor 240 and other passive elements 250.

The core 110 material can be magnetic powder materials such as iron powder, iron silicon aluminum (FeSiAl), iron nickel (FeNi), iron silicon chromium (FeSiCr), nanocrystalline, amorphous, or a mixture of several of these magnetic powders. The magnetic core 110 and the winding 120/130 are integrally pressed to form the top inductor 100. The first winding 120 comprises a third vertical part 121, a first bottom-horizontal part 122, a first vertical part 123, a top-horizontal part 124, a second vertical part 125, a second bottom-horizontal part 126 and a fourth vertical part 127, and are sequentially connected. The first pin 120a and the second pin 120b of the first winding 120 are both arranged on the bottom surface of the inductor 100, and the first pin 120a and the second pin 120b protrude out of the bottom surface of the magnetic core so as to realize reliable welding with the bottom substrate 210. The second winding 130 includes a third vertical portion 131, a first bottom-horizontal portion 132, a first vertical portion 133, a top-horizontal portion 134, a second vertical portion 135, a second bottom-horizontal portion 136, and a fourth vertical portion 137, and are sequentially connected. The first pin 130a and the second pin 130b of the second winding 130 are both arranged on the bottom surface of the inductor, and the first pin 130a and the second pin 130b protrude out of the bottom surface of the magnetic core so as to realize reliable welding with the bottom substrate 210. The third vertical part 121, the top-horizontal part 124 and the fourth vertical part 127 of the first winding 120 are partially exposed on the surface of the magnetic core 110, and the other parts of the first winding are arranged in the magnetic core. The third vertical portion 131, the top-horizontal portion 134, and the fourth vertical portion 137 of the second winding 130 are partially exposed on a surface of the magnetic core 110, and other portions of the second winding are disposed inside the magnetic core.

The IPM unit 220/230 includes two semiconductor switching devices and a drive control circuit thereof, which may be a silicon (Si)/silicon carbide (SiC) field effect transistor or the like. The two semiconductor switches are connected in series to form a switch bridge arm (equivalent to a half-bridge topological structure), and the two semiconductor switches are respectively a high-end switch and a low-end switch. The drain electrode of the high-end switch is electrically connected with the input positive end Vin+, and the source electrode of the high-end switch and the drain electrode of the low-end switch are electrically connected and led out to serve as the SW pin of the IPM unit. The source of the low-end switch is connected to the ground GND. The first pin 120a of the first winding 120 and the first pin 130a of the second winding 130 (i.e., the input end of the inductor) are respectively electrically connected to the SW pin of the corresponding IPM unit. A second pin 120b of the first winding 120 and a second pin 130b of the second winding 130 (i.e., the output end of the inductor) are electrically connected to the load to provide energy for the load. In the embodiment, the I/O pin 221, the Vin+ pin 222, the GND pin 223 and the SW pin 225 of the first IPM unit 220 are arranged in sequence, and the SW pin 225 is arranged adjacent to the first side surface of the bottom substrate. The pin setting of the second IPM unit 230 is the same as that of the first IPM unit 220 (not shown). The bottom substrate 210 is used for being welded to a load mainboard. Therefore, an I/O pad 211, a Vin+ pad 212, a GND pad 213 and a Vo+ pad 214 are sequentially arranged at the bottom of the bottom substrate 210. I/O pad is adjacent to the first side surface of the bottom substrate 210. An input capacitor 240 is disposed between the two IPM units. The first pin 120a/130a of each winding is arranged adjacent to the first side surface of the bottom substrate 210, so that the first pin 120a of the first winding is close to the SW pin of the first IPM unit 220, and the first pin 130a of the second winding is close to the SW pin of the second IPM unit 230, so that nearby electrical connection is realized, and the connection loop and the connection impedance are reduced, so that the conversion efficiency of the VRM module is improved.

The arrangement of the pads on the bottom substrate 210 and the arrangement of the pins of the IPM unit and the placement position of the inductor winding pins make the input power flows into the Vin+ pin 222 of the IPM unit 220 from the Vin+ pad 212 on the bottom substrate. When the high-end switch of the IPM unit is turned on and the low-end switch is turned off, the input power current flows from the Vin+ pin 222 to the second pin 120b through the SW pin 225 and the first pin 120a of the inductor 120, and flows to the load through the Vo+ pad 214 of the bottom substrate 210 to supply power to the load; meanwhile, energy is stored in the inductor, and the output capacitor at the load end is charged. When the high-end switch is turned off and the low-end switch is turned on, the energy stored in the inductor is released to the load to maintain the power supply to the load, and the current in the inductor is freewheeling through the SW pin 225 of the IPM unit 220, the GND pin 223 and the GND pad 213 of the bottom substrate. As the load is a processor, the power supply voltage of the processor is low (generally lower than 1V), and the input voltage of the load mainboard is generally about 12V and is far higher than the power supply voltage of the processor; therefore, the current flowing through the VIN path is small, and the current flowing through the GND path is large; the conduction time of the high-end switch of the IPM unit is short, and the conduction time of the low-end switch is long; therefore, the conduction loss of the low-end switch is high, and the low-end switch is a main heating source; and therefore the part with the highest temperature rise of the IPM unit 220 is a low-end switch close to the SW pin.

FIG. 1C is a side view of the magnetic core 110 shown in FIG. 1A along section A-A. The IPM unit 220 serves as a heat source (shown as a hot spot 300). The thermal path of the hot spot 300 has the following three: the first thermal path 311 is a downward thermal path from the bottom substrate 210 to the load main board; the second thermal path 312 is an upward thermal path through the bottom substrate 210 and the inductor winding 120 to the upper of the inductor; and the third thermal path 313 is an upward thermal path through the magnetic core to the upper of the inductor. The thermal resistance of the first thermal path 311 is low, but because the temperature of the load mainboard is relatively high, the heat of the IPM unit 220 conducted through the first thermal path 311 is less. The VRM module can be provided with a radiator at the top of the inductor, or the VRM module can share the radiator with the processor, and heat generated by the IPM unit 220 is dissipated through the top of the inductor. Therefore, as long as the thermal resistance of the IPM unit 220 to the top of the inductor is reduced, the heat dissipation capability of the second thermal path can be enhanced. In order to reduce the thermal resistance of the second thermal path 312, the first pin 120a of the inductor winding is close to the SW pin of the IPM unit 220 as much as possible, and the sectional area of the first winding 120 is increased; the first winding 120 is exposed on the surface of the magnetic core 110 at the top of the inductor, that is, the top-horizontal part 124 of the winding is exposed on the outer surface of the magnetic core 110; in this way, one end 120a of the first winding 120 is close to the heat source, and the top-horizontal part 124 exposing the top of the inductor is close to the radiator, so that the thermal resistance of the second thermal path 312 is reduced, and the heat dissipation performance of the VRM module is improved. In order to reduce the thermal resistance of the third thermal path, the thermal interface material 310 coated between the upper surface of the IPM unit 220 and the lower surface of the magnetic core. The thermal conductive medium is not limited to thermal adhesive, thermal grease, thermal pad, thermal tape and the like. Similarly, the heat dissipation path of the second IPM unit 230 is the same as that of the IPM unit 220.

FIG. 1D is a preferred embodiment of the present embodiment. As shown in FIG. 1D, the embodiment has the same technical effect as the embodiment shown in FIG. 1A. The difference in the embodiment lies in that the first bottom-horizontal part 122 and the second bottom-horizontal part 126 of the first winding 120 are partially exposed on the bottom surface of the magnetic core 110, and the exposed surfaces of the first bottom-horizontal part 122 and the second bottom-horizontal part 126 of the first winding 120 are flush with the bottom surface of the magnetic core 110. Therefore, in the embodiment, the fourth thermal path is added to the VRM module, which is an upward thermal path from the top surface of the IPM unit 220, passing through the thermal interface material 310, the first to the first bottom-horizontal part 122 and the second bottom-horizontal part 126 of the winding 120, due to the fact that the copper has good heat conduction performance, the upward thermal resistance of the VRM module is further reduced. The second IPM unit 230 and the second winding 130 also have the same arrangement and technical effects.

### Embodiment 2

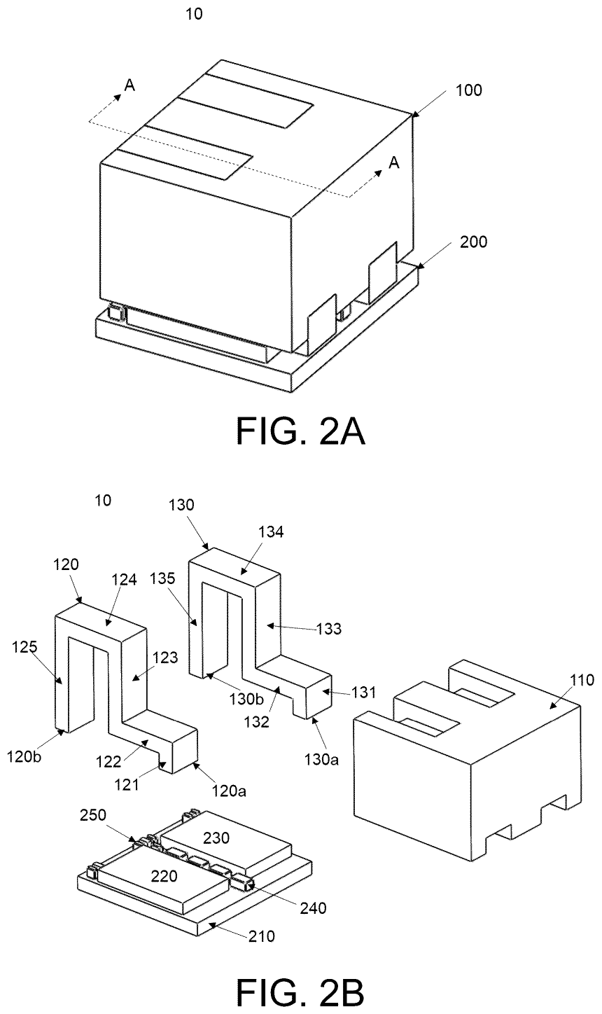

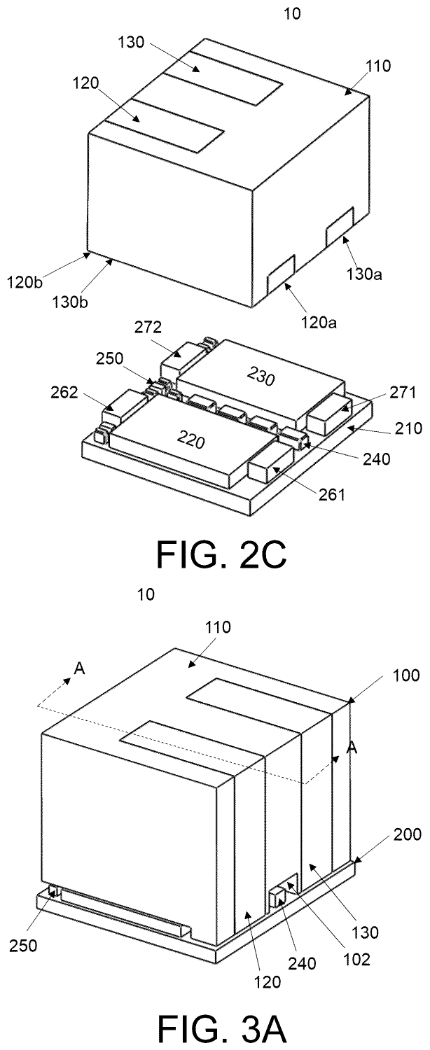

FIG. 2A shows another embodiment of the present invention, and FIG. 2B is an exploded view of the structure of FIG. 2A. The embodiment has the same technical effect as Embodiment 1, and the difference of the embodiment is that the winding structure of the inductor and the arrangement mode of the winding in the magnetic core 110. As shown in FIG. 2A and FIG. 2B, the first winding 120 includes a third vertical part 121, a first bottom-horizontal part 122, a first vertical part 123, a top-horizontal portion 124, and a second vertical portion 125, and are sequentially connected. The third vertical part 121, the first bottom-horizontal part 122, the top-horizontal part 124 and the second vertical part 125 of the first winding 120 are partially exposed on the surface of the magnetic core, and only the first vertical part 123 is completely wrapped by the magnetic core 110. The first bottom-horizontal part 122 is flush with the bottom surface of the magnetic core 110, and the top-horizontal portion 124 is flush with the top surface of the magnetic core 110. The first pin 120a and the second pin 120b of the first winding both protrude out of the bottom surface of the magnetic core 110, so as to realize reliable welding with the bottom substrate 210. The winding group has the advantage that the inductance of the inductor can be flexibly adjusted, so that the application range of the VRM module is expanded. The low-end switch of the IPM unit 220 is adjacent to the first side surface of the bottom substrate 210, and the first winding 120 with the heat dissipation function is closer to the heat source IPM unit 220. In this embodiment, the length of the first bottom-horizontal portion 122 of the first winding 120 in the horizontal direction is increased, so that the winding is in a larger-area interface with the heat source, the upward thermal resistance of the VRM module is reduced, a better heat dissipation effect is achieved, and the output current of the VRM module is further increased. The second IPM unit 230 and the second winding 130 have the same arrangement mode and technical effect as the first IPM unit 220 and the first winding 120.

FIG. 2C is a preferred embodiment of the embodiment. The embodiment has the same technical effect as the embodiment shown in FIG. 2A. The difference of the embodiment lies in the arrangement mode of pins of the inductor winding. In the embodiment, the first pin 120a and the second pin 120b of the first winding 120 and the first pin 130a and the second pin 130b of the second winding 130 are all flush with the bottom surface of the magnetic core. Copper columns 261/262/271/272 are disposed on the top surface of the bottom substrate 210. Pins 120a/120b/130a/130b of the inductor are electrically connected to the bottom substrate 210 by means of copper columns 261/262/271/272, respectively. In this way, the manufacturing process of the inductor can be simplified, and meanwhile, good heat dissipation capability can be obtained.

### Embodiment 3

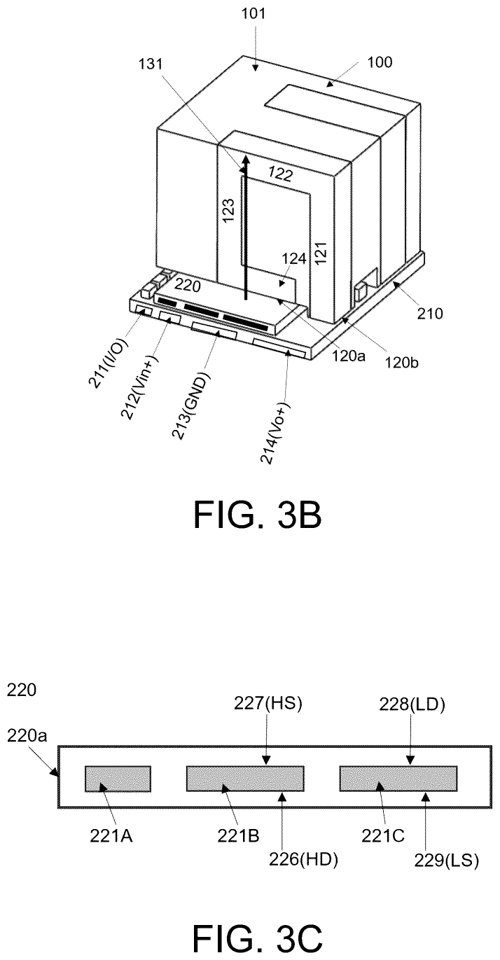

FIG. 3A is a schematic structural diagram of a VRM module according to another embodiment of the present invention, and FIG. 3B illustrates a cross-sectional view of the magnetic core 110 (shown in FIG. 3A) obtained by cutting along A-A position. As shown in FIG. 3A and FIG. 3B, the VRM module comprises a top inductor 100 and a bottom assembly 200, the top inductor 100 comprises a magnetic core 110, the first winding 120 and the second winding 130. The magnetic material of the magnetic core 110 can be formed by iron powder, iron-silicon-aluminum, iron-nickel, iron-silicon-chromium, nanocrystalline, amorphous and other magnetic powder materials or a mixture thereof. The magnetic core 110 and the winding are integrally press-formed. In the embodiment, the bottom of the magnetic core 110 is provided with a groove 102. The first winding 120 comprises a first bottom-horizontal part 122, a first vertical part 123, a top-horizontal part 124 and the second vertical part 125. The first winding 120 is in an unsealed “ [symbol] ” shape, and the unsealed position is arranged between the second vertical part 125 and the first bottom-horizontal part 122. The second vertical part 125, the first bottom-horizontal part 122 and the top-horizontal portion 124 are partially exposed on the surface of the magnetic core 110, and only the first vertical portion 123 is completely wrapped by the magnetic core 110. The outer exposed surface of the top-horizontal part 124 is flush with the top surface of the magnetic core 110, and the outer exposed surface of the first bottom-horizontal part 122 is flush with the bottom surface of the magnetic core 110. The second vertical portion 125 is disposed adjacent to a first side surface of the magnetic core 110. The first pin 120a and the second pin 120b of the first winding are both arranged on the bottom surface of the magnetic core 110, and the second pin 120b protrudes out of the second pin 120b of the first winding.

The bottom assembly 200 includes a bottom substrate 210, a first IPM unit 220, a second IPM unit 230 (not shown), an input capacitor 240 and other passive elements 250. The input capacitors 240 are disposed within a recess 102 of the magnetic core 110. An I/O pad 211, a Vin+ pad 212, a GND pad 213 and a Vo+ pad 214 are sequentially arranged on the bottom substrate 210; and the Vot pad 214 is arranged adjacent to the first side surface of the bottom substrate 210. Referring to the side view shown in FIG. 3C, the IPM unit 220 comprises an IPM unit substrate 220a, an I/O functional area 221A, a high-end switch 221B, a low-end switch 221C and an RDL (Re-distributed layer-redistribution layer, not shown), and the like. The switch in the IPM unit may be a silicon (Si)/silicon carbide (SiC) field effect transistor or the like. The IPM unit 220 is disposed adjacent to a first side surface of the substrate 210. The I/O functional region 221A is disposed adjacent to a third side surface (the third side surface is opposite to the first side surface) of the bottom substrate 210. In the embodiment, the switch adopts a vertical structure MOSFET, namely the drain electrode 226 of the high-end switch 221B is adjacent to the bottom surface of the IPM unit, and the source electrode 227 is adjacent to the top surface of the IPM unit; the drain electrode 228 of the low-end switch 221C is adjacent to the top surface of the IPM unit, and the source electrode 229 is adjacent to the bottom surface of the IPM unit. The two semiconductor switch are electrically connected in series to form a switch bridge arm (equivalent to a half-bridge topological structure); the drain electrode 226 of the high-end switch is electrically connected with the input positive end Vint; the source electrode 227 of the high-end switch is electrically connected with the drain electrode 228 of the low-end switch; the source electrode 227 of the high-end switch is electrically connected with the drain electrode 228 of the low-end switch through the RDL in the substrate 220a and is led out to serve as the SW pin of the IPM unit; and the SW pin of the IPM is led out on the top surface and the bottom surface of the substrate 220a; and the source 229 of the low-end switching is connected with the input ground GND. The first pin 120a of the first winding 120 is electrically connected with the SW pin of the IPM unit, and the second pin is electrically connected with the load to provide energy for the load. The arrangement of the second IPM unit 230 and the second winding 130 is the same as that of the first IPM unit 220 and the first winding 120.

In the embodiment, the drain electrode 226 of the high-end switch is arranged on the bottom surface of the high-end switch silicon wafer, and the bottom surface of the IPM unit substrate 220a is led out through the RDL to serve as the Vin+ pin (not shown in the figure) of the IPM unit, so that electrical connection with the Vin+ pad 212 of the bottom substrate is facilitated. The source electrode 227 of the high-end switch and the drain electrode 228 of the low-end switch are both arranged on the top surface of the corresponding switch silicon wafer, and are led out to the SW pin (not shown) of the IPM unit 220 on the top surface of the IPM unit substrate 220a through the RDL, so that it's easy to electronical connected with the first pin 120a of the inductor. A source electrode 229 of the low-end switching is arranged on the bottom surface of the low-end switch silicon wafer, and is led out as a GND pin (not shown in the figure) of the IPM unit to the IPM unit substrate 220a through the RDL, so that electrical connection with the GND pad 213 of the bottom substrate is facilitated. The second pin 120b is electrically connected with the Vot pad of the bottom substrate through the bottom substrate 210 to provide energy for the load. Therefore, the arrangement has the advantages that the path of the power loop is the shortest, and the conversion efficiency of the VRM module can be improved. The loop area of the input high-frequency loop is minimum so that the frequency of high-frequency oscillation of the input loop is far away from the equivalent switching frequency, the influence of high-frequency oscillation of the input loop on the working stability of the VRM module is reduced, extra loss caused by loop oscillation is reduced, and the conversion efficiency of the VRM module is further improved.

As described in Embodiment 1, the conduction loss of the low-end switch in the IPM unit is high, and dominates the loss of the IPM unit, so that the low-end switch is a main heat source. According to the embodiment, the first pin 120a of the first winding 120 is directly electrically connected with the SW pin of the IPM unit on the top surface of the substrate 220a of the IPM unit 220, so that the thermal resistance from the low-end switch to the top surface of the inductor is reduced, and the VRM module can output larger current.

### Embodiment 4

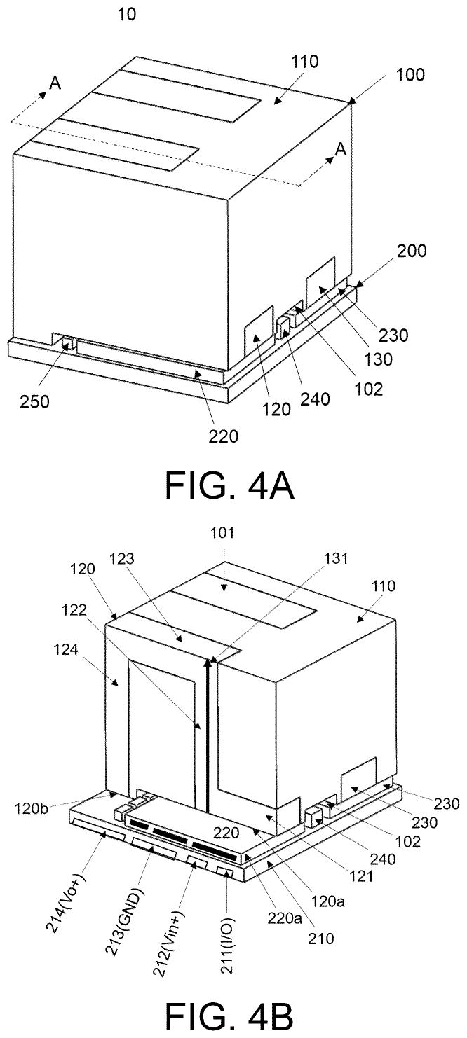

FIG. 4A is a schematic structural diagram of a VRM module according to another embodiment of the present invention, and FIG. 4B illustrates a cross-sectional view of the magnetic core 110 (shown in FIG. 4A) obtained by cutting along A-A position. As shown in FIG. 4A and FIG. 4B, the embodiment has the same technical effect as the embodiment shown in FIG. 3A. The difference between the embodiment and the embodiment in FIG. 3A is that the shape of the winding and the position of the IPM unit and the pin position of the bottom substrate are briefly described as follows.

The winding 120 includes a first bottom-horizontal part 122, a first vertical portion 123, a top-horizontal part 124, and a second vertical part 125. The first bottom-horizontal part 122, the top-horizontal part 124, and the second vertical portion 125 are all partially exposed outside the magnetic core 110, and only the first vertical part 123 is completely surrounded by the magnetic core 110. The outer exposed surface of the top-horizontal part 124 of the winding is flush with the top surface of the magnetic core 110, and the outer exposed surface of the second vertical part 125 is arranged close to the third side surface of the magnetic core 110. The first pin 120a and the second pin 120b of the winding are both arranged on the bottom surface of the magnetic core 110, and the first pin 120a of the winding is lower than the second pin 120b.

An I/O pad 211, a Vin+ pad 212, a GND pad 213 and a Vo+ pad 214 are sequentially arranged on the bottom substrate 210 and are adjacent to a third side surface of the bottom substrate 210. The first IPM unit 220 and the second IPM unit 230 are arranged on the bottom substrate 210 and are arranged close to the first side surface of the bottom substrate 210. Referring to FIG. 3C, a low-side switch 229 of the IPM unit is disposed close to a first side surface of the IPM unit substrate 220a.

The first pin 120a of the first winding 120 is electrically connected with the SW pin (not shown) arranged on the top surface of the IPM unit substrate 220a, so that the thermal resistance of the low-end switch of the first IPM unit from the silicon wafer to the top surface of the inductor is reduced, the VRM module has good heat dissipation performance, and the output current of the module is improved.

The connection between the second winding 130 and the second IPM unit 230 is the same as the connection setting of the first winding 120 and the first IPM unit 220 and has the same technical effect.

### Embodiment 5

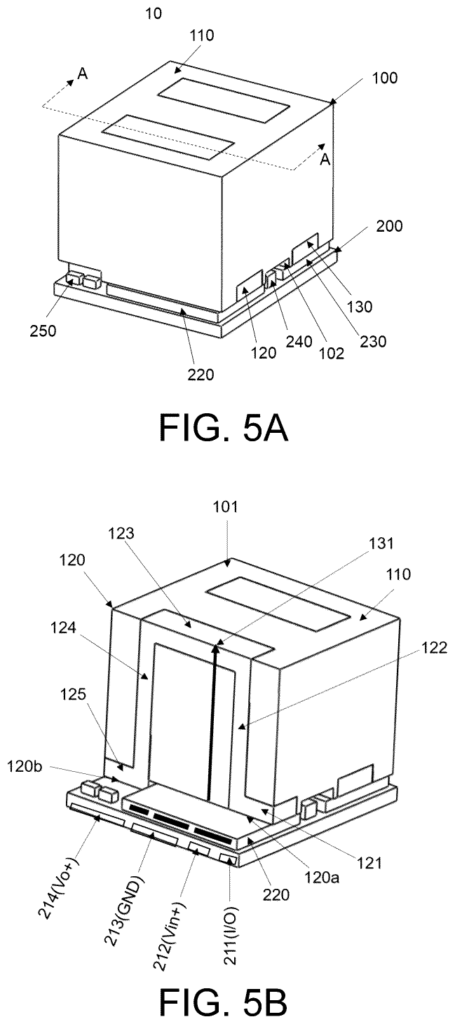

FIG. 5A is a schematic structural diagram of a VRM module according to another embodiment of the present invention, and FIG. 5B illustrates a cross-sectional view of the magnetic core 110 (shown in FIG. 5A) obtained by cutting along A-A position. As shown in FIG. 5A and FIG. 5B, the embodiment has the same technical effect as the embodiment shown in FIG. 4A, and the difference between the embodiment and the embodiment shown in FIG. 4A is the shape of the winding; and the winding in the embodiment is in a “ [symbol] ” shape. The first winding 120 comprises a first bottom-horizontal part 122, a first vertical part 123, a top-horizontal part 124, a second vertical part 125 and a second bottom-horizontal part 126, the first bottom-horizontal part 122, the top-horizontal part 124 and the second bottom-horizontal part 126 are partially exposed on the surface of the magnetic core, and the first vertical part 123 and the second vertical part 125 are arranged inside the magnetic core and completely surrounded by the magnetic core 110. The exposed surface of the top-horizontal part 124 is flush with the top surface of the magnetic core. The first pin 120a and the second pin 120b are both arranged on the bottom surface of the magnetic core, and the shape structure of the second winding 130 of the first pin 120a lower than that of the second pin 120b is the same as the shape structure of the first winding 120 and has the same technical effect.

### Embodiment 6

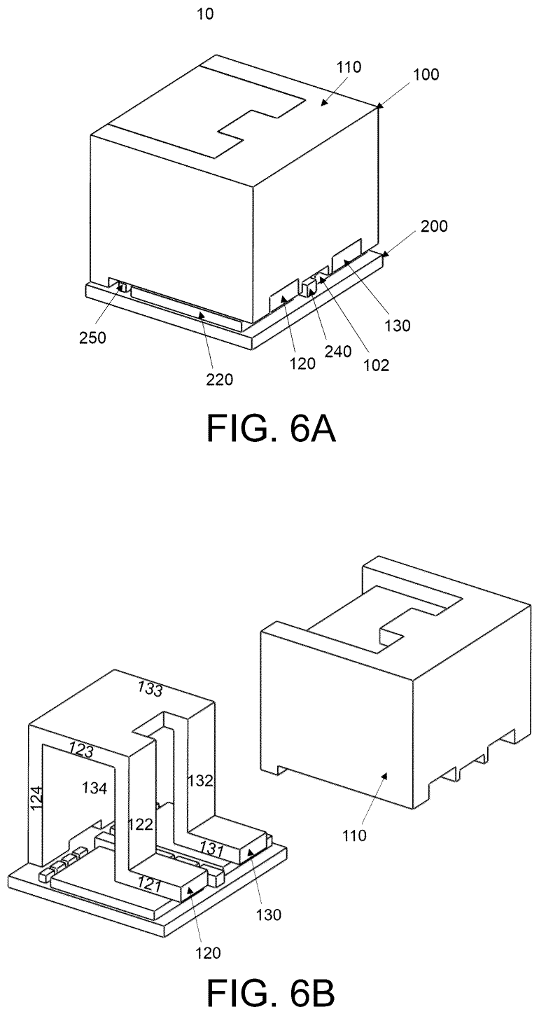

FIG. 6A is a schematic structural diagram of a VRM module according to another embodiment of the present invention, and FIG. 6B is an exploded view of the structure of FIG. 6A. As shown in FIG. 6A and FIG. 6B, the embodiment has the same technical effect as the embodiment shown in FIG. 4A, and the difference of the embodiment is the structure of the winding. The first winding 120 includes a first bottom-horizontal portion 122, a first vertical part 123, a top-horizontal part 124 and a second vertical part 125; the second winding 130 comprises a first bottom-horizontal part 132, a first vertical part 133, a top-horizontal part 133 and a second vertical part 135. The top-horizontal part 124 and the second vertical part 125 of the first winding are physically connected together with the top-horizontal part 134 and the second vertical part 134 of the second winding, and are partially exposed on the surface of the magnetic core 110. The winding structure shown in the embodiment has the advantages that the direct-current impedance of the winding is reduced, and the power conversion efficiency is improved; and on the other hand, the increased copper cross-sectional area of the winding enhances the heat dissipation effect, and the output current capability of the VRM module is further improved. In other embodiment, only the top-horizontal part 124 of the first winding and the top-horizontal part 134 of the second winding are physically connected. Alternatively, only the second vertical portion 125 of the first winding and the second vertical portion 135 of the second winding are physically connected.

### Embodiment 7

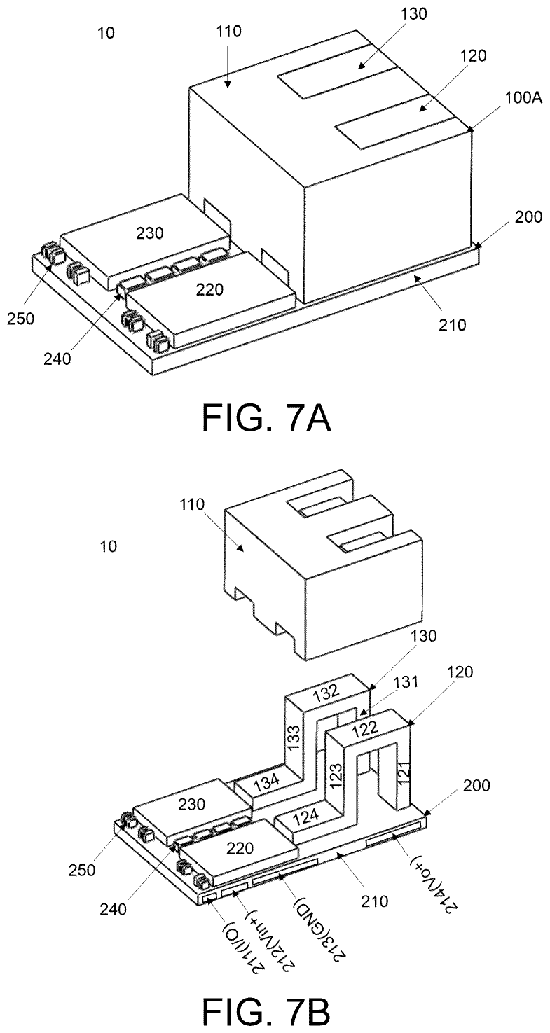

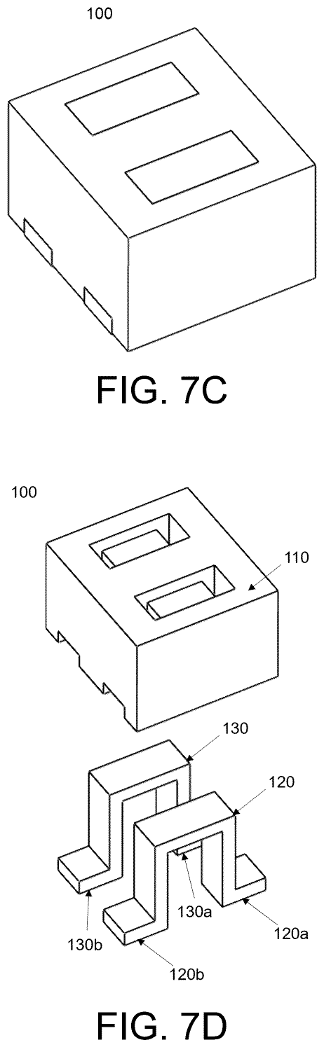

FIG. 7A is a schematic structural diagram of a VRM module 10 according to another embodiment of the present invention, and FIG. 7B is an exploded view of the structure of FIG. 7A. As shown in FIG. 7A and FIG. 7B, the difference between the present embodiment and the foregoing embodiments is: the inductor in the VRM module and the IPM unit are vertically stacked; the inductor and the IPM unit in the VRM shown in the embodiment are horizontally placed, so that the arrangement has the advantages that the top of the IPM unit and the inductor can be directly and thermally connected with the radiator, heat generated by the IPM unit and the inductor can be directly dissipated through the radiator, the upward thermal resistance of the IPM unit and the inductor is reduced, and larger current output by the VRM module is facilitated.

FIG. 7C is a schematic structural diagram of another inductor 100 that can be used in the VRM module 10 of the present embodiment, and FIG. 7D is an exploded view of the structure of FIG. 7C. As shown in FIG. 7C and FIG. 7D, the inductor shown in the embodiment has the same technical effect as the inductor shown in FIG. 1A. The difference between the inductor shown in the embodiment and the inductor shown in FIG. 1A is that the first pin 120a and the second pin 120b of the first winding 120 shown in the embodiment and the first pin 130a and the second pin 130b of the second winding 130 are arranged on the same plane, or the pins of the two windings are flush with the bottom surface of the magnetic core 110, so that the space utilization rate and the power density of the VRM module are improved. The structure of the inductor pin protruding from the bottom surface of the magnetic core in FIG. 1A can also be used in the VRM module of the embodiment. Similarly, the inductor structure, the pins of the winding arranged on the same plane, can be used in all the above embodiments.

In another preferred embodiment, the substrate 210 of the bottom assembly 200 may be a load mainboard, so that a substrate 210 is saved, a large current welding point of the power loop is reduced, loss caused by the substrate 210 is eliminated, the cost of the VRM module is reduced, and the production efficiency is improved. Similarly, the bottom substrate 210 in the VRM module according to the first to sixth embodiments can be replaced by a load mainboard, which has the same technical effect as the embodiment.

### Embodiment 8

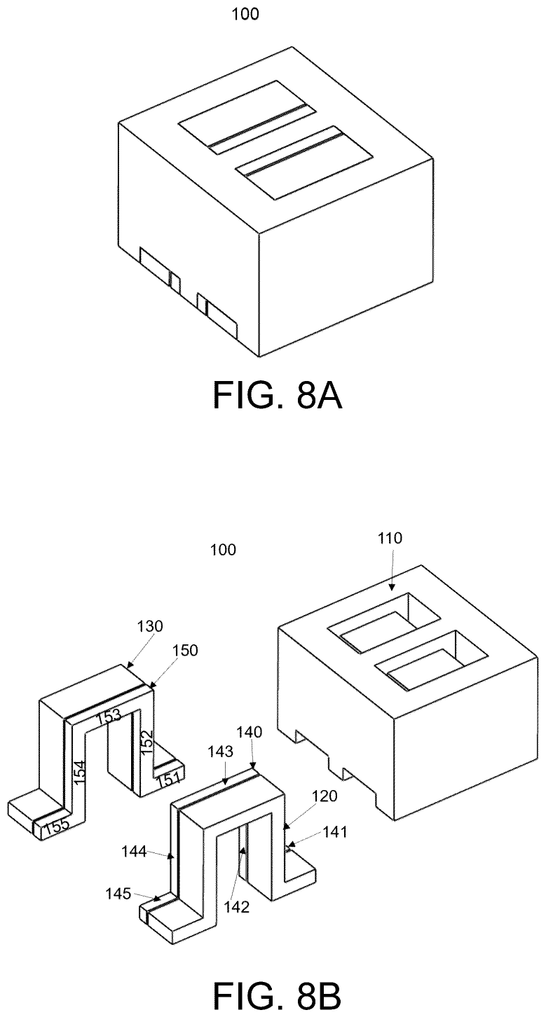

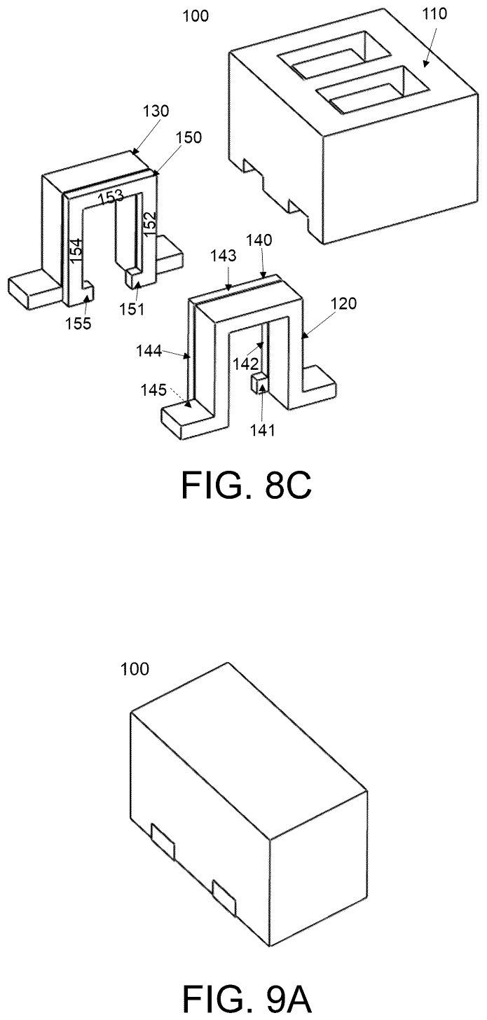

FIG. 8A is another embodiment of the inductor 100 in the VRM module of the present invention, and FIG. 8B is an exploded view of the structure of FIG. 8A. The difference between the inductor shown in FIG. 8A and the inductor shown in FIG. 7A is that the inductor in FIG. 8A is additionally provided with a first auxiliary winding 140 and a second auxiliary winding 150, the first auxiliary winding 140 and the first winding 120 have the same structural shape and are adjacently arranged, and the width of the first auxiliary winding 140 is smaller than that of the first winding 120. The second auxiliary winding 150 and the second winding 130 have the same structural shape and are adjacently arranged; and the width of the second auxiliary winding 150 is smaller than that of the second winding 130. In the embodiment, the first auxiliary winding 140 is arranged adjacent to the first winding 120, the second auxiliary winding 150 is arranged adjacent to the second winding 130, and in order to increase the coupling coefficient between the auxiliary winding and the winding, a TLVR (Trans-Inductor Voltage Regulator) technology is realized; and the dynamic performance of the VRM module is further improved while the upward thermal resistance of the VRM module is reduced, and the heat dissipation performance is improved. In one voltage regulation module, two auxiliary windings are electrically connected in series through the bottom substrate, and two functional extension pins are correspondingly arranged on the lower surface of the bottom substrate. When multiple voltage regulation modules are installed on the system motherboard, the auxiliary windings of different voltage regulation modules are electrically connected through the functional extension pins.

FIG. 8C is another preferred embodiment of the present embodiment, and the embodiment shown in FIG. 8C has the same technical effect as the embodiment shown in FIG. 8A. The difference in the embodiment shown in FIG. 8C is that the structure of the auxiliary winding is different, and specifically, the first bottom-horizontal part 142 and the second bottom-horizontal part 146 of the first auxiliary winding 140 respectively extend inwards; the shape of the first vertical part 143, the top-horizontal part 144 and the second vertical part 145 is the same as the shape of the corresponding part of the first winding 120, and is disposed adjacent with the first winding 120. The second auxiliary winding 150 has the same structure as the first auxiliary winding 140, and is disposed adjacent to the second winding 130. The structure shape of the auxiliary winding in the embodiment is that the connection between the pins of the auxiliary winding and the substrate 210 or the load mainboard is simpler and more convenient.

### Embodiment 9

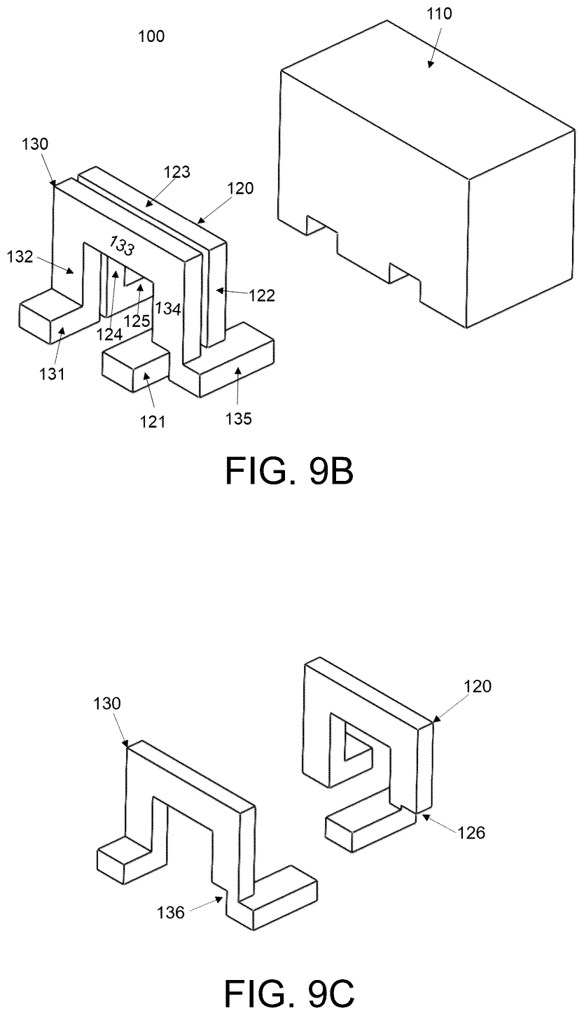

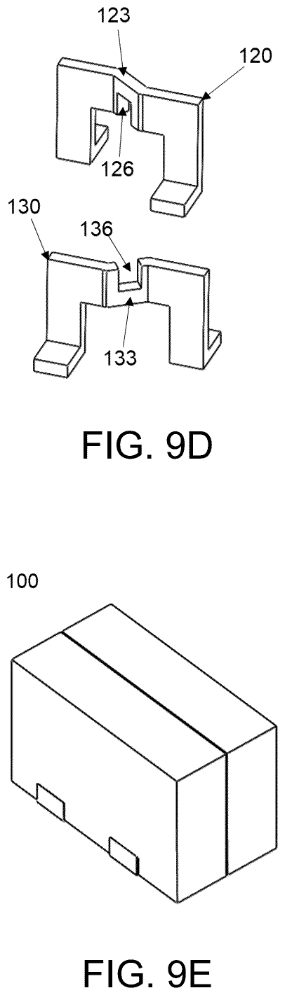

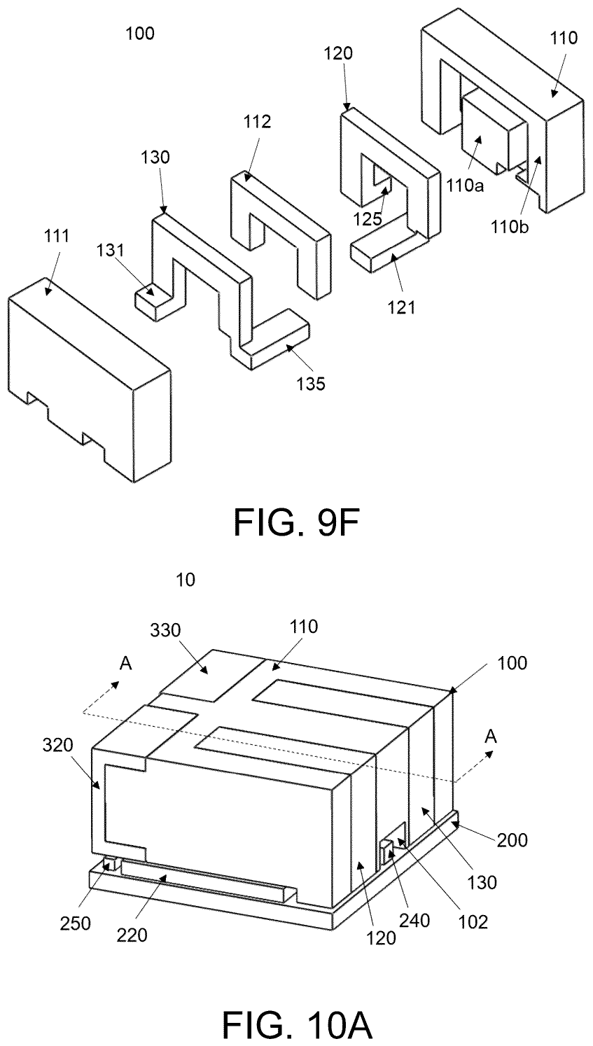

FIG. 9A is another embodiment of the inductor 100 in the VRM module of the present invention, and FIG. 9B is an exploded view of the structure of FIG. 9A. As shown in FIG. 9A and FIG. 9B, the inductor comprises a magnetic core 110, the first winding 120 and the second winding 130. The magnetic core in this embodiment has the same technical effect as the magnetic core shown in Embodiment 1. The first winding 120 includes a first bottom-horizontal part 122, a first vertical part 123, a top-horizontal part 124, a second vertical part 125, and a second bottom-horizontal part 126. The first bottom-horizontal part 122 and the second bottom-horizontal part 126 are partially exposed on the surface of the magnetic core, or the outer exposed surfaces of the first bottom-horizontal portion 122 and the second bottom-horizontal part 126 are flush with the bottom surface of the magnetic core. The first bottom-horizontal part 122 extends toward the second side surface of the magnetic core, and the second bottom-horizontal part 126 extends toward the fourth side surface of the magnetic core. The second winding 130 includes a first bottom-horizontal part 132, a first vertical part 133, a top-horizontal part 134, a second vertical part 135, and a second bottom-horizontal part 136. The first bottom-horizontal part 132 and the second bottom-horizontal part 136 are partially exposed on the surface of the magnetic core, or the outer exposed surfaces of the first bottom-horizontal part 132 and the second bottom-horizontal part 136 are flush with the bottom surface of the magnetic core. The first bottom-horizontal part 132 extends toward the second side surface of the magnetic core, and the second bottom-horizontal part 136 extends toward the fourth side surface of the magnetic core. FIG. 9C is an exploded view of the structure of the winding in FIG. 9B. As shown in FIG. 9C, the first winding 120 is provided with a first notch 128, and the first notch 128 is provided at a combination portion of the first bottom-horizontal part 122 and the first vertical part 123. The second winding 130 is provided with a second notch 138, and the second notch 138 is arranged at the combination part of the second vertical part 135 and the second bottom-horizontal part 136. The first winding 120 and the second winding 130 are arranged in a crossed configuration through the mechanical interlock between the notch 128 and the second bottom-horizontal part 136, and the mechanical interlock between the notch 138 and the first bottom-horizontal part 122. The arrangement of the notches 128 and 138 is to achieve electrical isolation and insulation requirements when the two windings are disposed adjacent to each other.

The first pin 120a of the first winding is arranged at the bottom of the first bottom-horizontal part 122, and is electrically connected with the SW pin of the first IPM unit through the bottom substrate 210 or the load mainboard. The first pin 130a of the second winding 130 is arranged at the bottom of the first bottom-horizontal part 132, and is electrically connected with the SW pin of the second IPM unit through the bottom substrate 210 or the load mainboard. The first pin 120a of the first winding 120 and the first pin 130a of the second winding 130 are arranged close to the same side surface of the magnetic core 110, for example, adjacent to the second side surface of the magnetic core 110. The second pin 120b of the first winding 120 is arranged at the bottom of the second bottom-horizontal part 126, and is electrically connected with the load through the bottom substrate 210 or the load mainboard, and provides energy for the load. The second pin 130b of the second winding 130 is arranged at the bottom of the second bottom-horizontal part 136, is electrically connected with the load through the bottom substrate 210 or the load mainboard, and provides energy for the load. The second pin 120b of the first winding 120 and the second pin 130b of the second winding 130 are disposed close to the same side surface of the magnetic core 110, such as a fourth side surface of the magnetic core 110. That is, two input pins of the inductor are arranged close to the same side face of the magnetic core 110, and two output pins of the inductor are arranged close to the other same side surface of the magnetic core. In this way, the distance from the output pin of the inductor to the load is the shortest, the direct current impedance of the current flowing path is effectively reduced, and the conversion efficiency of the VRM module is improved.

The current in the VRM module flows out from the SW pin and supplies power to the load after passing through the inductor winding, that is, the current flows out from the output pin of the inductor. Therefore, the current flowing through the first winding 120 in the embodiment flows in from the first pin 120a and flows out from the second pin 120b of the first winding 120; and the current flowing through the second winding 130 flows in from the first pin 130a and flows out from the second pin 130b of the second winding 130. The current direction flowing through the first vertical part 123, the top-horizontal part 124 and the second vertical part 125 of the first winding 120 is opposite to the current direction flowing through the first vertical part 133, the top-horizontal part 134 and the second vertical part 135 of the second winding 130; and the magnetic flux generated by the current flowing through the two windings is opposite in direction in the magnetic core 110 and mutually counteracted, so that the two-phase inductor works in an anti-coupling state. On one hand, the anti-coupling inductor has a small dynamic sense, and the dynamic performance of the VRM module can be improved; and on the other hand, the anti-coupling has relatively high steady-state inductance, and the VRM module can obtain steady-state characteristics.

FIG. 9D illustrates another embodiment of the winding of FIG. 9A. As shown in FIG. 9D, the winding shown in FIG. 9D has the same technical effect as the winding described in FIG. 9A. The difference between the windings shown in FIG. 9D is that the positions where the notches are provided are different. The first winding 120 is provided with a notch 128 on the top-horizontal portion 124. The second winding 130 is provided with notch 138, and the notch 136 on the top-horizontal portion 134. The first winding 120 and the second winding 130 are arranged in a crossed configuration through the mechanical interlock between the notch 128 and the notch 138. The requirements of electrical isolation and insulation of the two windings are met when the two windings are arranged adjacent to each other. Of course, the notches can also be arranged at other positions, which are not listed one by one herein.

FIG. 9E is a schematic structural diagram of another embodiment of the inductor according to the embodiment, and FIG. 9F is an exploded view of the structure of FIG. 9E. As shown in FIG. 9E and FIG. 9F, the inductor 100 comprises a first magnetic core 110, a second magnetic core 111, a third magnetic core 112, a first winding 120 and a second winding 130. The first magnetic core 110 and the second magnetic core 111 are composed of magnetic materials with high magnetic conductivity, such as ferrite, so as to improve the coupling coefficient between the two windings. The first magnetic core 110 is provided with a middle column 110a and a side column 110b, and an air gap can be further arranged on the column 110a so as to adjust the inductance. The third magnetic core 112 is made of a magnetic material with low magnetic permeability, such as the magnetic powder core material in embodiment 1. Therefore, the saturation current value of the inductor is improved. The winding shown in the embodiment is the same as the winding in the embodiment shown in FIG. 9A. Therefore, the two-phase winding in the embodiment is also working in an anti-coupling state, and the dynamic performance and the steady-state efficiency of the VRM module can be considered.

### Embodiment 10

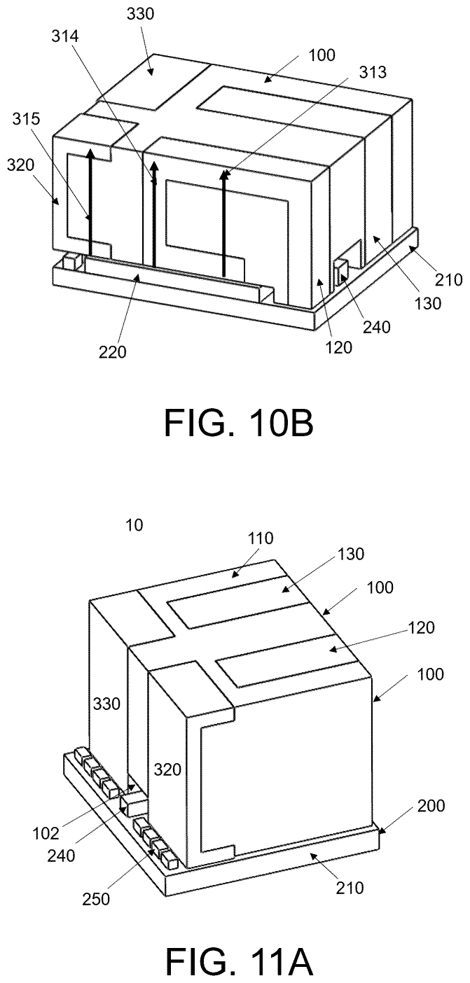

Another embodiment of the embodiment shown in FIG. 3A is shown in the embodiment, as shown in FIG. 10A and FIG. 10B. FIG. 10A is a schematic structural diagram, and FIG. 10B is a schematic diagram of the position A-A shown in FIG. 10A. Different from the VRM module shown in FIG. 3A, in this embodiment, the heat dissipation assemblies 320 and 330 are both “C”-shaped, are provided on the side surface of the magnetic core 110, and extend to the top surface and the bottom surface of the magnetic core.

In the embodiment, the heat dissipation assemblies 320 and 330 are two independent heat dissipation assemblies which can be copper sheets, but are not limited thereto, and can also be made of aluminum or other alloy materials and materials with good heat conduction characteristics. In other embodiments, the heat dissipation assemblies 320 and 330 may also be integrally formed, that is, the heat dissipation assemblies 320 and 330 are connected to form a whole on the bottom surface, the side surface and/or the bottom surface. The heat dissipation assembly 320 is thermally connected to the top surface of the first IPM 220 on the bottom surface of the magnetic core, or is connected to the heat dissipation bonding pad on the top surface of the first IPM unit 220 in a welded manner; and the heat dissipation assembly 330 is thermally connected to the top surface of the first IPM unit 230 on the bottom surface of the magnetic core, or is connected to the heat dissipation bonding pad on the top surface of the second IPM unit 230 in a welded manner. The heat dissipation assemblies 320 and 330 are thermally connected to the heat sink on the top surface of the magnetic core. Therefore, as shown in FIG. 10B, the thermal path 315 from the heat source to the top surface of the magnetic core is added, the vertical upward thermal resistance of the module is further reduced, a better heat dissipation effect is obtained, and the reliability of the VRM module is further improved. The heat dissipation assembly shown in the invention can be copper, aluminum or alloy, and has good heat conduction characteristics.

### Embodiment 11

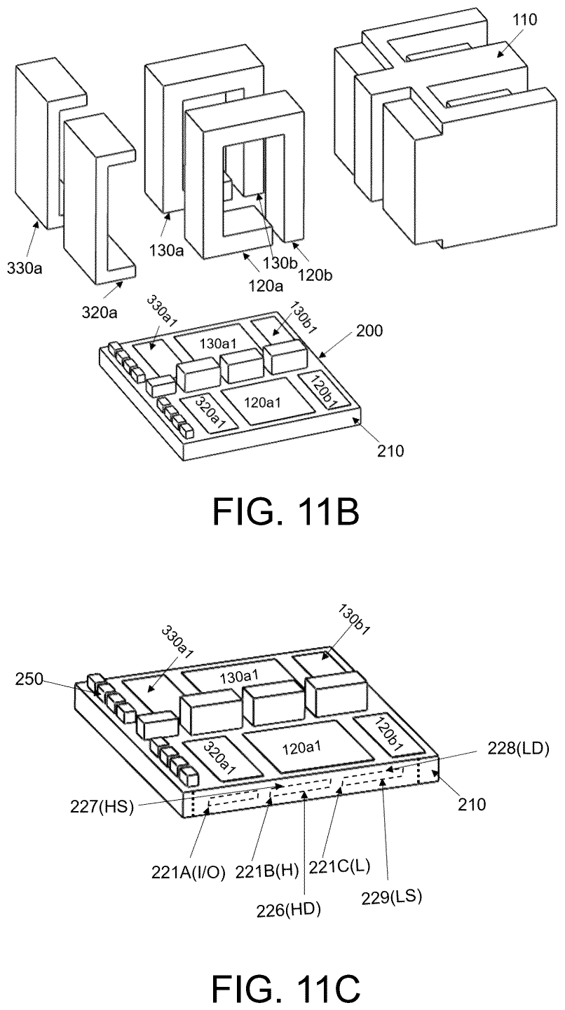

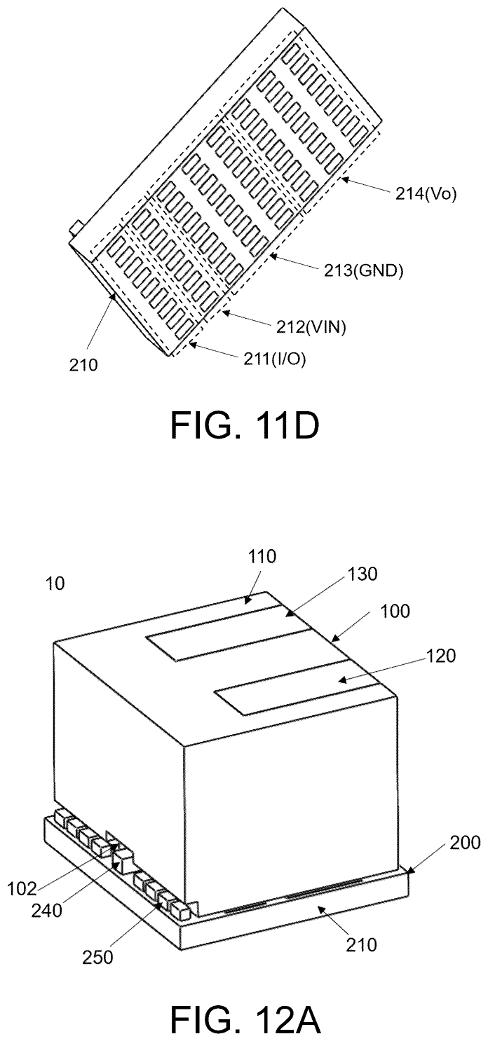

FIG. 11A is another embodiment of the VRM module 10 according to the present invention, except that the structure of the bottom assembly 200 is different from that of the previous embodiment. FIG. 11B is an exploded view of the structure of FIG. 11A, FIG. 11C is a perspective view of the bottom assembly 200, and FIG. 11D is a schematic diagram of a bottom pin of the bottom assembly 200. Referring to FIG. 11A to FIG. 11D, the first IPM unit 220 and the second IPM unit 230 are embedded in the bottom substrate 210. In other embodiments, the first IPM unit 220 and the second IPM unit 230 in a bare silicon die may also be directly embedded.

An SW pin 120a1/130a1, a Vo pin 120b1/130b1 and a heat dissipation pad 320a1/330a1 are arranged on the top surface of the bottom substrate 210; the SW pin 120a1 is electrically connected to the first pin 120a of the first winding 120, and the SW pin 130a1 is electrically connected to the first pin 130a of the second winding 130; the Vo pin 120b1 is electrically connected to the second pin 120b of the first winding 120, and the Vo pin 130b1 is electrically connected to the second pin 130b of the second winding 130; a heat dissipation pad 320a1 is thermally connected to a pin 320a of the heat dissipation assemblies 320, and a pin 330a of the heat dissipation pad 330a1 thermally connected to the heat dissipation assemblies 330. The IPM unit embedded in the substrate 210 comprises an I/O function area 221A, a high-end switch 221B and a low-end switch 221C, and are sequentially arranged in the bottom substrate 210. In the embodiment, the high-end switch 221B and the low-end switch 221C both adopt a vertical conductive channel technology MOSFET, the drain electrode 226 of the high-end switch 221B is arranged on the bottom surface of the switch, and the source electrode 227 is arranged on the top surface of the switch; the drain electrode of the low-end switch 221C is arranged on the top surface of the switch, and the source electrode is arranged on the bottom surface of the switch. The drain electrode 227 of the high-end switch 221B and the drain electrode 228 of the low-end switch 221C are electrically connected to the SW pin 120a1 by means of a via hole electroplating or a redistribution layer in the substrate 210.

An I/O pad 211, a Vin+ pad 212, a GND pad 213 and a Vo+ pad 214 are arranged on the bottom surface of the bottom substrate 210, and are sequentially arranged according to the sequence; however, in other embodiments, the arrangement of the pin regions is not limited thereto, as long as nearby connection can be met, and wiring parasitic parameters are reduced. The drain electrode 226 of the high-end switching 221B is electrically connected with the VIN pin 212 on the bottom surface of the substrate in a manner of electroplating through a via hole or a redistribution layer in the substrate 210; and the source electrode 229 of the low-end switching 221C is electrically connected with the GND pad 213 on the bottom surface of the substrate in a manner of electroplating through a via hole or a redistribution layer in the substrate 210; and the VO pin 120b1 is electrically connected with the Vo+ pad 214 on the bottom surface of the substrate 210 in a via hole electroplating mode or a redistribution layer; the I/O functional area 221A of the switching is electrically connected with other passive elements 250 on the top surface of the substrate 210 in a via electroplating mode or a redistribution layer, and the other electrode of the passive element 250 is electrically connected with the I/O pad 211 on the bottom surface of the substrate 210 in a via hole electroplating mode or a redistribution layer. According to the embodiment, the IPM unit or the Bare Die is embedded in the substrate, so that the bonding pad on the top surface of the substrate is on the same plane, welding assembly of the inductor and the substrate is facilitated, and meanwhile, the downward heat conduction performance of the IPM or Bare Die is better.

### Embodiment 12

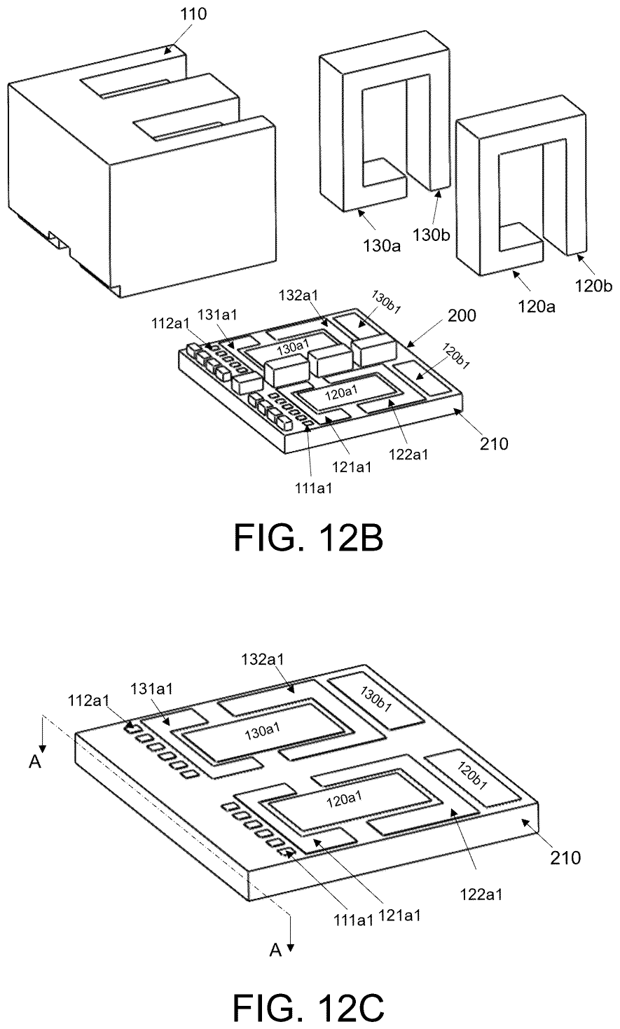

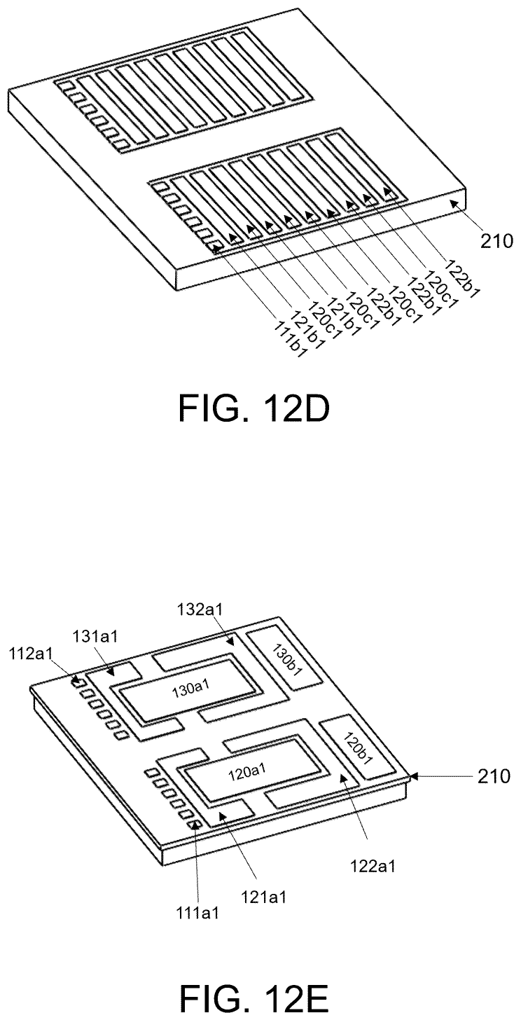

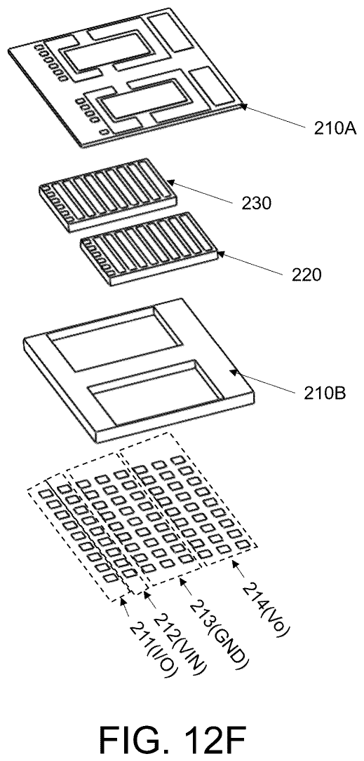

FIG. 12A is another embodiment of the VRM module 10 disclosed in the present invention, FIG. 12B is an exploded view of the structure of FIG. 12A, FIG. 12C is a schematic structural diagram of the bottom assembly 210, and FIG. 12D is a cross-sectional view of the bottom assembly 210 at the A-A position. As shown in FIG. 12A to FIG. 12D, the difference between the embodiment and the eleventh embodiment lies in that an IPM unit embedded in a bottom substrate is a MOSFET or a bare silicon wafer (Bare Die) of a planar conductive channel technology. In the embodiment, the pins of the IPM unit are arranged on the same surface, and after the IPM unit is embedded into the bottom substrate, the pins of the IPM unit face the top surface of the substrate 210.

SW pins 120a1/130a1 and Vo pins 120b1/130b1 are arranged on the top surface of the bottom substrate 210; the SW pin 120a1 is electrically connected to the first pin 120a of the first winding 120, and the SW pin 130a1 is electrically connected to the first pin 130a of the second winding 130; the Vo pin 120b1 is electrically connected to the second pin 120b of the first winding 120, and the Vo pin 130b1 is electrically connected to the second pin 130b of the first winding 130 and the top surface of the bottom substrate 210 is further provided with signal connection lines 111a1/112a1, the Vin connection line 121a/131a1 and the GND connection line 122a1/132a1; and an I/O pad 211, a Vin+ pad 212, a GND pad 213 and a Vo+ pad 214 are arranged on the bottom surface of the bottom substrate 210, and are sequentially arranged according to the sequence. The signal connection lines 111a1/112a1, the SW pins 120a1/130a1, the VIN connection lines 121a1/131a1 and the GND connection lines 122a1/132a1 of the top surface of the substrate are led out from pins of the IPM unit in the substrate to the top surface of the substrate in a punching and electroplating mode or a redistribution layer from pins of the IPM; and the signal connection lines 111a1/112a1, the VIN connection lines 121a1/131a1, and the GND connection lines 122a1/132a1 are electrically connected to the I/O pads 211, the VIN+ pads 212, and the GND pads 213 on the bottom surface of the substrate by means of a redistribution layer or a punching and electroplating in the substrate; and the Vo pin 120b1/130b1 of the top surface of the substrate is electrically connected with the Vo+ pad 214 on the bottom surface of the substrate in a punching electroplating or redistribution layer mode. As shown in FIG. 12D, the pin layout of the IPM unit is GND, VIN and SW are alternately arranged.

As shown in FIG. 12E, which is another embodiment of the present embodiment, the bottom assembly 200 includes a first substrate 210A and a packaging material 210B. FIG. 12F is an exploded view of FIG. 12E. With reference to FIG. 12E and FIG. 12F, the top surface of the first substrate 210A is provided with pins identical to that of FIG. 12C, IPM units and/or capacitors (not shown) are welded or bonded to the bottom surface of the first substrate 210A, the IPM units and/or the capacitors are packaged by means of the packaging material 210B, and pins are formed on the bottom surface of the packaging material; the connection mode of the pins is the same as the effect of FIG. 12C, and details are not described herein again. The layout arrangement in the embodiment facilitates the upward heat dissipation of the IPM unit, also eliminates the loss caused by the power electrical connector, and is beneficial to the further improvement of the efficiency of the VRM module.

The bottom assembly structures shown in the first embodiment and the twelfth embodiment can be suitable for any embodiment of the first embodiment to the tenth embodiment, and a person skilled in the art can obtain the same technical effect through simple adjustment and combination.

The related technical features of the inductor or the VRM module can be randomly matched for use, and corresponding technical effects can be obtained. The embodiment is only limited. The copper column used for conducting electricity in the invention can also be other metal materials, and is not limited to copper.

The outer exposed surface of the winding is flush with the magnetic core, and the “flush ” is only under the visual condition and is located on the same horizontal plane. the outer exposed surface of the winding can be lower than the surface of the magnetic core due to the process precision, such as less than 100 μm; and due to the need of a subsequent process; the outer exposed surface of the winding, especially the outer exposed surface provided with the bonding pad, may be higher than the outer surface of the magnetic core, and the maximum height difference is 150 μm.

The VRM module shown in the invention can also be part of the electronic device, and the technical features and advantages disclosed by the invention can be met.

The “equal” or “same” or “equal to” disclosed by the application needs to consider the parameter distribution of engineering, and the error distribution is within +/−30%; and the included angle between the two line segments or the two straight lines is less than or equal to 45 degrees; the included angle between the two line segments or the two straight lines is within the range of [60, 120]; and the definition of the phase error phase also needs to consider the parameter distribution of the engineering, and the error distribution of the phase error degree is within +/−30%.

The embodiments in the specification are described in a progressive manner, each embodiment focuses on the difference from other embodiments, and the same similar parts between the embodiments can be referred to each other.

The above description of the disclosed embodiments enables a person skilled in the art to implement or use the present application. Various modifications to these embodiments will be readily apparent to those skilled in the art, and the generic principles defined herein may be implemented in other embodiments without departing from the spirit or scope of the application. Thus, the present application will not be limited to the embodiments shown herein but is to be accorded the widest scope consistent with the principles and novel features disclosed herein.

What is claimed is:

1. A inductor assembly with low thermal resistance, comprising:
a magnetic core and a winding;
wherein the winding comprises a first winding and a second winding;
wherein the magnetic core comprises a top surface and a bottom surface which are opposite each other, a first surface and a third surface which are opposite each other, a second surface and a fourth surface which are opposite each other; wherein the first surface, the second surface, the third surface, and the fourth surface are arranged between the top surface and the bottom surface;
wherein the first winding and second winding both comprise a top-horizontal part, a first vertical part, a second vertical part, a first bottom-horizontal part, a first pin, and a second pin;
wherein the first pin and the second pin are arranged on the bottom surface of the magnetic core; the upper surface of the top-horizontal part is exposed on the top surface of the magnetic core; the top ends of the first and second vertical parts connect to respective ends of the top-horizontal part; the bottom end of the first vertical part connects to one end of the first bottom-horizontal part; the lower surface of the first bottom-horizontal part is exposed on the bottom surface of the magnetic core; the first vertical part is disposed adjacent to the first pin; the second vertical part is disposed adjacent to the second pin.

2. The inductor assembly of claim 1, wherein a side surface of the second vertical part is exposed on a side surface of the magnetic core.

3. The inductor assembly of claim 1, wherein the first bottom-horizontal part extends from the first vertical part toward a side surface of the magnetic core away from the second vertical part.

4. The inductor assembly of claim 3, further comprising:
a third vertical part;
wherein the top end of the third vertical part connects to the other end of the first bottom-horizontal part; the first pin is disposed on the bottom end of the third vertical part.

5. The inductor assembly of claim 1, wherein the first pin is disposed on the bottom surface of the first bottom-horizontal part.

6. The inductor assembly of claim 5, wherein the first bottom-horizontal part extends to the second vertical part.

7. The inductor assembly of claim 1, wherein the second pin is disposed on the bottom end of the second vertical part.

8. The inductor assembly of claim 1, further comprising:
a second bottom-horizontal part;
wherein one end of the second bottom-horizontal part connects with the bottom end of the second vertical part; the second bottom-horizontal part extends from the second vertical part away from the first vertical part; the second pin is disposed on the bottom surface of the second bottom-horizontal part.

9. The inductor assembly of claim 1, further comprising:
a second bottom-horizontal part and a fourth vertical part;
wherein one end of the second bottom-horizontal part connects with the bottom end of the second vertical part; the other end of the second bottom-horizontal part connects with the top end of the fourth vertical part; the second pin is disposed on the bottom end of the fourth vertical part.

10. The inductor assembly of claim 2, wherein the second vertical part of the first winding and the second vertical part of the second winding connect each other; or
the top-horizontal part and the second vertical part of the first winding connect with the top-horizontal part and the second vertical part of the second winding.

11. The inductor assembly of claim 1, further comprising:
a heat dissipation assembly;
wherein the heat dissipation assembly is in “C” shape, wrapping part of the top surface, part of the side surface, and part of the bottom surface of the magnetic core;
wherein the heat dissipation assembly is made of metal material.

12. The inductor assembly of claim 1, wherein the first winding comprises a first notch, and the first notch is arranged on the bottom surface of the top-horizontal part of the first winding;
wherein the second winding comprises a second notch, and the second notch is arranged on the top surface of the second winding;
wherein the first winding and the second winding are arranged in a crossed configuration through a mechanical interlock between the first notch and the second notch.

13. The inductor assembly of claim 8, wherein the first winding comprises a first notch, and the first notch is arranged at the combination part of the first bottom-horizontal part and the first vertical part of the first winding;
wherein the second winding comprises a second notch, and the second notch is arranged at the combination part of the second bottom-horizontal part and the second vertical part of the second winding;
wherein the first winding and the second winding are arranged in a crossed configuration through a mechanical interlock between the first notch and the second bottom-horizontal part of the second winding, and through a mechanical interlock between the second notch and the first bottom-horizontal part of the first winding.

14. The inductor assembly of claim 1, wherein the first pin of the first winding and the first pin of the second winding are arranged adjacent the same side surface of the magnetic core;
wherein the second pin of the first winding and the second pin of the second winding are arranged adjacent the other same side surface of the magnetic core.

15. The inductor assembly of claim 1, wherein the bottom ends of the first winding and the second winding are flush with the bottom surface of the magnetic core; or
the bottom ends of the first winding and the second winding both protrude out of the bottom surface of the magnetic core; or
the bottom end of the first pin is flush with the bottom surface of the magnetic core, the bottom end of the second pin protrudes out of the bottom surface of the magnetic core.

16. The inductor assembly of claim 1, further comprising:
a first auxiliary winding and a second auxiliary winding;
wherein the first auxiliary winding is arranged adjacent to the first winding, and the second auxiliary winding is arranged adjacent to the second winding;
the first auxiliary winding and the second auxiliary winding both comprises a top-horizontal part, a first vertical part, and a second vertical part;
shapes of the top-horizontal part, the first vertical part, and the second vertical part of the first auxiliary winding and the second auxiliary winding are same as shapes of the top-horizontal part, the first vertical part, and the second vertical part of the first winding and the second winding.

17. The inductor assembly of claim 1, wherein a magnetic powder, the first winding, and the second winding are integrally pressed to form the inductor assembly.

18. The inductor assembly of claim 1, wherein the magnetic core comprises a first magnetic core, a second magnetic core, and a third magnetic core;
wherein the third magnetic core is arranged between the first winding and the second winding; the first magnetic core and the third magnetic core are arranged two opposite side surfaces of the first winding; the second magnetic core and the third magnetic core are arranged at two opposite side surfaces of the second winding.

19. The inductor assembly of claim 18, wherein the first magnetic core is provided with a middle column and a side column; the first magnetic core and the second magnetic core are made of a magnetic material with low magnetic permeability; the third magnetic core is made of a magnetic material with low magnetic permeability.

20. A voltage regulator module with low thermal resistance, comprising:
a bottom assembly and the inductor assembly of claim 1;
wherein the bottom assembly includes a bottom substrate, a first IPM unit, and a second IPM unit;
wherein the first IPM unit and the second IPM unit are arranged on an upper surface of the bottom substrate or embedded in the bottom substrate;
wherein each of the first IPM unit and the second IPM unit comprises a high-end switch, a low-end switch, and an SW pin, and the high-end switch and the low-end switch are electrically connected to the SW pin;
wherein the inductor assembly is arranged on a top surface of the bottom substrate and arranged above the first IPM unit and the second IPM unit; the bottom surface of the bottom substrate is used for fixing and electrically connecting with an external assembly; the second pins are electrically connected with the bottom substrate, the first pin of the first winding is electrically connected with the first IPM unit, the first pin of the second winding is electrically connected with the second IPM unit.

21. The voltage regulator module of claim 20, wherein the top-horizontal part is thermally connected with the heat dissipation device arranged on the top surface of the magnetic core.

22. The voltage regulator module of claim 20, further comprising:
an input capacitor and other passive components;
wherein the input capacitor and other passive components are arranged on the top surface of the bottom substrate; the input capacitor is arranged between the first IPM unit and the second IPM unit.

23. The voltage regulator module of claim 22, wherein the bottom of the magnetic core is provided with a groove, and the groove is used for accommodating the input capacitor and other passive components.

24. The voltage regulator module of claim 20, wherein an I/O pad, a Vin+ pad, a GND pad, and a Vo+ pad are sequentially arranged on the bottom surface of the bottom substrate; and the I/O pad is arranged adjacent to the first side surface of the bottom substrate.

25. The voltage regulator module of claim 20, wherein the bottom surface of the magnetic core is thermally connected with the top surface of the bottom substrate or the IPM unit.

26. The voltage regulator module of claim 20, wherein the inductor assembly further comprises a heat dissipation assembly;
wherein the heat dissipation assembly is in “C” shape, wrapping part of the top surface, part of the side surface, and part of the bottom surface of the magnetic core;
wherein the heat dissipation assembly is made of metal material, and a bottom surface of the heat dissipation assembly is thermally connected with the top surface of the IPM unit or the bottom substrate.

27. The voltage regulator module of claim 20, wherein the bottom surface of the first bottom-horizontal part is thermally connected with the top surface of the IPM unit.

28. The voltage regulator module of claim 27, wherein the SW pin of the IPM unit is arranged on the top surface of the IPM unit; the bottom surface of the first bottom-horizontal part is fixed and electrically connected with the SW pin.

29. The voltage regulator module of claim 27, wherein a thermal interface material is provided between the top surface of the IPM unit and the bottom surface of the magnetic core, and between the top surface of the IPM unit and the bottom surface of the first bottom-horizontal part.

30. The voltage regulator module of claim 27, wherein the inductor assembly further comprises a third vertical part;
wherein the top end of the third vertical part connects to the other end of the first bottom-horizontal part; the first pin is disposed on the bottom end of the third vertical part; the SW pin of the IPM unit is electrically connected with the first pin through the substrate.

31. The voltage regulator module of claim 27, wherein the second pin is disposed on the bottom end of the second vertical part, and the second pin is fixed and electrically connected with the bottom substrate.

32. The voltage regulator module of claim 27, wherein the inductor assembly further comprises a second bottom-horizontal part;
wherein one end of the second bottom-horizontal part connects with the bottom end of the second vertical part; the second bottom-horizontal part extends from the second vertical part away from the first vertical part; the second pin is disposed on the bottom surface of the second bottom-horizontal part; the second pin is fixed, thermally connected and electrically connected with the bottom substrate.

33. The voltage regulator module of claim 27, wherein the inductor assembly further comprises a second bottom-horizontal part and a fourth vertical part;
wherein one end of the second bottom-horizontal part connects with the bottom end of the second vertical part; the other end of the second bottom-horizontal part connects with the top end of the fourth vertical part; the second pin is disposed on the bottom end of the fourth vertical part;
wherein the bottom surface of the second bottom-horizontal part is thermally connected with the top surface of the IPM unit; the second pin is fixed and electrically connected with the bottom substrate.

34. The voltage regulator module of claim 33, wherein a thermal interface material is provided between the top surface of the IPM unit and the bottom surface of the second bottom-horizontal part.

35. The voltage regulator module of claim 20, wherein the bottom end of the second pin and the first pin is fixed and electrically connected with the bottom substrate through a metal column.

36. The voltage regulator module of claim 20, wherein the SW pin of the IPM unit is arranged adjacent to the first side surface of the bottom substrate, the first pin of the winding is arranged adjacent to the first side surface of the bottom substrate, and the SW pin and the first pin are arranged nearby.

37. The voltage regulator module of claim 20, wherein the inductor assembly further comprises a first auxiliary winding and a second auxiliary winding;
wherein the first auxiliary winding is arranged adjacent to the first winding, and the second auxiliary winding is arranged adjacent to the second winding;
the first auxiliary winding and the second auxiliary winding both comprises a top-horizontal part, a first vertical part, and a second vertical part;
shapes of the top-horizontal part, the first vertical part, and the second vertical part of the first auxiliary winding and the second auxiliary winding are same as shapes of the top-horizontal part, the first vertical part, and the second vertical part of the first winding and the second winding;
the first auxiliary winding and the second auxiliary winding in a same voltage regulator module are electrically connected in series through the bottom substrate, and a corresponding functional extension pin is arranged on the bottom surface of the bottom substrate.

38. The voltage regulator module of claim 20, wherein two notches are respectively provided on the first winding and the second winding;
wherein the first winding and the second winding are arranged in a crossed configuration through a mechanical interlock between the two notches.

39. A voltage regulator module with low thermal resistance, comprising:
an IPM unit, an input capacitor, other passive components, and the inductor assembly of claim 1;
wherein the IPM unit, the input capacitor, the other passive components, and the inductor assembly are arranged on the bottom substrate or the system mainboard;
the IPM unit and the inductor assembly are arranged on the same surface of the bottom substrate or the system mainboard;
the IPM unit is arranged on the upper surface of the bottom substrate;
the IPM unit comprises a high-end switch, a low-end switch, and SW pin, the high-end switch and the low-end switch are electrically connected with the SW pin;
the inductor is arranged on the top surface of the bottom substrate in coplanar alignment with the IPM unit;
the second pins are electrically connected with the bottom substrate; and
the first pin of the first winding and the SW pin of the first IPM unit are adjacently arranged and electrically connected.

40. The voltage regulator module of claim 39, wherein a pad of voltage regulator module is provided on the bottom surface of the bottom substrate, which is used for fixing and electrically connecting with an external assembly.

41. The voltage regulator module of claim 40, wherein the bottom substrate is a system mainboard;
wherein the IPM unit and the inductor assembly are electrically connected through the inductor assembly.
